(19) United States
(12) Patent Application Publication
(10) Pub. No.: US 2004/0203837 A1
(43) Pub. Date: Oct. 14, 2004

(54) Opportunistic channel assignments

(76) Inventor: Christopher Lawrence, Kirkland, WA (US)

Correspondence Address: CHRISTOPHER LAWRENCE, 13755 97TH AVE NE, KIRKLAND, WA, 98034, US

(21) Appl. No.: 10/263,840

(22) Filed: Oct. 2, 2002

(51) Int. Cl. H04Q 7/00

(52) U.S. Cl. 455/455; 455/452.1

(57) ABSTRACT

The invention relates to cellular mobile communications systems and more specifically to a system and method for efficiently managing system control signaling to optimize spectrum and other important system resources.

### TECHNICAL FIELD OF THE INVENTION

The invention relates to cellular mobile communications systems and more specifically to a system and method for managing two radios and their corresponding functions on a single radio channel. In particular, it pertains to a system and method whereby a radio functioning as a control channel and operating on a given center frequency f₀ may assign traffic to a second radio, supporting the delivery of voice and data, operating on the same center frequency f₀ thereby optimizing spectrum usage.

### BACKGROUND OF THE INVENTION

A cellular mobile communications system uses a large number of low-power wireless transmitters to create cells—the basic geographic service area of a wireless communications system. Variable power levels allow cells to be sized according to the subscriber density and demand within a particular region. As mobile users travel from cell to cell, their conversations are handed off between neighboring cells to maintain seamless service. In an effort to increase overall system capacity, channels (frequencies) used in one cell can be reused in another cell some distance away.

The concept of frequency reuse is based on assigning to each cell a group of radio channels to be used within the cell's small geographic service area and, through proper engineering practices, managing reuse of this group some number of cells away. In analog cellular systems, each channel group contains a dedicated control channel that assists with management of call control between mobile phones within the cell's service area and the remaining voice channels within the channel group. Although certain reuse schemes suggest the number of channels in each frequency group, the capacity requirement within the cell's service area is typically used to define the total number of required channels. However, regardless of the number of voice channels apportioned to a given cell, one channel must be dedicated to control thereby reducing the effective number of channels available for voice or data transmission, and, correspondingly reducing the overall service capabilities of the cellular system.

Although analog systems were originally devised in the late 1970s, AMPS (Advanced Mobile Phone Service), released in 1983, represented the first standardized cellular service. As a result, AMPS became extremely successful throughout the world, achieving notable popularity in the United States, South America, China, and Australia (AMPS has been deployed on every continent except Europe and Antarctica). However, as demand for mobile telephone service increased, service providers found that analog systems were quickly becoming saturated, and service quality was decreasing rapidly. By the late 1980s cellular operators in the U.S. were looking for ways to relieve a critical capacity problem.

Through the 1990s two primary methods were introduced to support the continuing growth in wireless communications: digital technologies and additional, PCS (Personal Communications Systems) spectrum. However, this additional capacity did not come without cost; multiple digital standards and multiple operating bands introduced incompatibilities for users, limiting their ability to roam between the various systems. Partly as a result of this situation, the FCC (Federal Communications Commission) took action to improve the quality and reliability of 911 emergency services for wireless phone users by adopting rules to govern the availability of basic 911 services. Chief among these rules are the elements that govern the availability of analog resources:

all mobile phones manufactured for sale in the United States after Feb. 13, 2000, that are capable of operating in an analog mode, including dual-mode and multi-mode handsets, must include a special method for processing 911 calls; and,

wireless carriers must transmit all 911 emergency calls without engaging in billing or validation procedures. Calls from subscribers and non-subscribers alike must be forwarded, without delay, to the appropriate public safety operator.

For cellular system operators in the U.S., these FCC orders eliminate the option of entirely decommissioning analog services, as they must remain commissioned for compatibility purposes.

As the penetration of digital subscribers continues to grow, the allocation of spectrum resources to analog services becomes increasingly less efficient. In fact, for most cellular operators today the migration of users to digital services has been so successful that the decision to continue sustaining analog services is largely based on support for emergency services as ordered by the FCC. Increasingly this implies that for a given cell as few as one voice channel is required to meet all analog requirements, capacity and regulatory, and; correspondingly, the spectrum allocated for the control channel function has become extremely underutilized, inefficient.

Traditionally, cellular operators would seek relief with such technology challenges by approaching the governing standards bodies or their equipment manufacturers. Unfortunately, as such relates to analog cellular systems, neither standards bodies nor manufacturers are focused on finding elegant solutions for such a legacy technology. Further, even if such designs were made available, they would likely be so at the relatively high cost of replacing existing analog-based equipment. Since cellular operators possess a glut of analog equipment, a less expensive and more expedient option involves the use of ancillary equipment or logic, retrofitted to the existing analog infrastructure.

### SUMMARY OF THE INVENTION

The instant invention relieves the aforementioned problem by making available the spectrum normally occupied by the control channel to service channels (voice or data channels) when said control channel has no further service channels to assign (i.e., all service channels are active). The invention defines the capability for a control channel radio, operating on a center frequency f₀, to assign traffic to a second radio, supporting the delivery of voice and data and operating on the same center frequency f₀.

When all radios have been assigned, the functionality of a control channel is minimized. In a mature system where each control channel must manage numerous service channels, the control channel duty cycle is large (i.e., it is busy much of the time). As the number of service channels decreases, so does the duty cycle of the control channel. As the number of service channels approaches one, the control channel duty cycle trends very close to zero—its need is minimized when all service radios in the cell are serving traffic. This fact makes it possible to spectrum share with the last assigned service channel in a pool of service channels.

In Embodiment One (1), the invention can be implemented by incorporating additional software logic to the existing call control software of the Mobile Switching Center (MSC). This embodiment of the invention takes advantage of the MSC's existing call processing capabilities but adds to it additional logic, referred to herein as the switching decision algorithm, such that, upon assignment of a service radio operating on channel f₀, the MSC orders the paired control channel radio, also operating on f₀, to power down for the duration of the service assignment thereby eliminating radio frequency (RF) interference with the service radio. Once the voice or data session is terminated or handed-off to a neighboring cell, the voice channel is naturally powered-down and the control channel subsequently powered-up in preparation for the next service request. One technical advantage of this embodiment is that, ideally, the entire solution can be realized by simply augmenting the centralized, MSC software thereby eliminating the need for any additional ancillary equipment. Also, this embodiment saves the carrier significant expense since there is no need to dispatch operational personnel to various cell sites as may be required by other approaches. One disadvantage to this approach is the implied dependence on the system vendor who may not deliver the solution in an expedite manner or for a competitive cost.

In Embodiment Two (2), the invention can be implemented by deploying ancillary logic such that system control messages between the cell site radios and the MSC are intercepted and altered to satisfy the additional switching decision algorithm defined by this invention and described in embodiment one. This approach requires ancillary equipment that can be deployed centrally (e.g., at an MSC) or in a distributed fashion (e.g., at individual cell sites), whichever best supports the architecture or operations of a given system. One advantage of this embodiment is that the carrier has more latitude in seeking suppliers of such a solution since adding the switching decision algorithm by means of a peripheral device largely eliminates dependency on the system vendor.

In Embodiment Three (3), the invention can be implemented by adding ancillary RF equipment to the cell site radio equipment thereby realizing the switching decision algorithm with the assistance of RF-based hardware. In this embodiment, RF sensing equipment is used to determine when the service radio, operating on center frequency f₀, has been powered on. When this condition occurs, a switching circuit transfers the output of the control channel radio, also operating on center frequency f₀, to a load effectively removing it from the remainder of the transmit chain thus eliminating RF interference with the aforementioned service radio. One advantage of this embodiment is that such RF circuits may be constructed from commonly available components and may be easily constructed by those skilled in the art. No special knowledge of proprietary system control messaging is required.

In Embodiment Four (4), the invention can be implemented by combining aspects of Embodiments 2 and 3 whereby ancillary logic is used to intercept service assignment messages to the service radios, determine when a service radio is operating on center frequency f₀ and, triggered off these system control messages, an RF switching circuit transfers the output of the control channel radio, also operating on a center frequency f₀, to a load effectively removing it from the remainder of the transmit chain thus eliminating RF interference with the aforementioned service radio.

In Embodiment Five (5), the invention can be implemented by combining aspects of Embodiments 2 and 3 whereby RF sensing equipment is used to determine when a service radio, operating on center frequency f₀, has been powered on and ancillary logic is then used to instruct the control channel radio, also operating on a center frequency f₀, to power-off thus eliminating RF interference with the aforementioned service radio.

The foregoing has outlined rather broadly the features and technical advantages of aspects of the present invention in order that the detailed description of the invention that follows may be better understood. Additional features and advantages of aspects of the invention will be described hereinafter, which form the subject of the claims of the invention. It should be appreciated by those skilled in the art that the conception and specific embodiments disclosed might be readily utilized as a basis for modifying or designing other systems or structures for carrying out the same purposes of any of many aspects of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of each embodiment of the present invention and the advantages thereof, reference is now made to the following descriptions taken in conjunction with the accompanying drawings, in which:

FIG. 1 is a block diagram of a cellular system and incorporated switching decision algorithm employing Embodiment 1 of the present invention;

FIG. 2 is a block diagram of a cellular system and incorporated switching decision algorithm employing Embodiment 2 of the present invention;

FIG. 3 is a block diagram of a cellular system and incorporated switching decision algorithm employing Embodiment 3 of the present invention;

FIG. 4 is a block diagram of a cellular system and incorporated switching decision algorithm employing Embodiment 4 of the present invention; and,

FIG. 5 is a block diagram of a cellular system and incorporated switching decision algorithm employing Embodiment 5 of the present invention.

### DETAILED DESCRIPTION

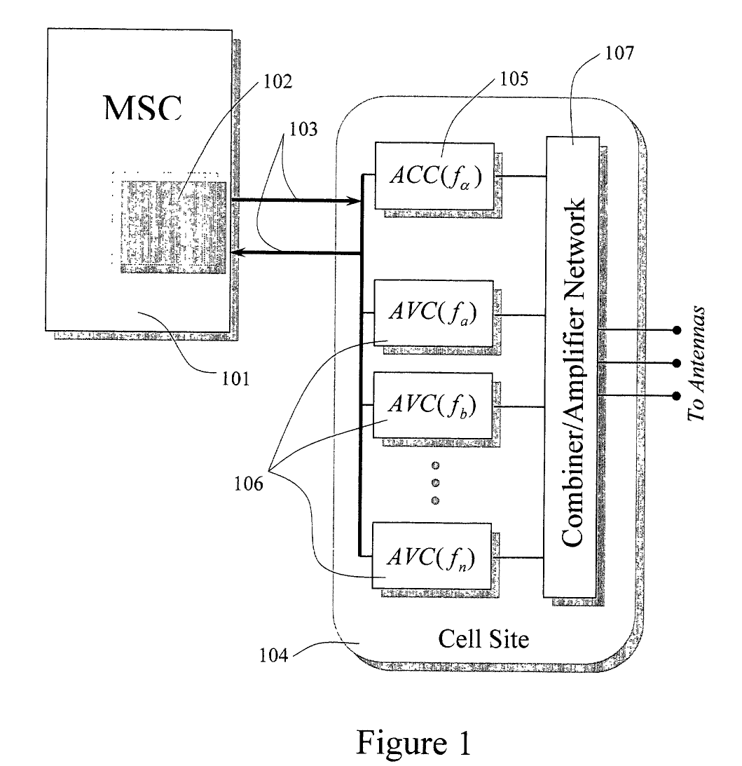

FIG. 1 is an illustrative example of a cellular system, depicting an MSC 101 in communication with one of many cell sites 104 via control links 103. Although the cell site may support additional technologies (e.g., CDMA, GSM, TDMA) and may be comprised of additional support equipment (e.g., power), for the sake of simplicity only the Analog Control Channel (ACC) 105, Analog Voice Channels (AVC) 106 and supporting Combiner/Amplifier Network 107 are depicted as detailed components. In the example, the ACC 105 is operating on frequency f_{α} and the AVCs are operating on frequencies fₐ, f_{b} through fₙ where “n” represents the nth AVC in a multi-radio configuration. In normal operation and configuration, each channel (control and voice) would be assigned a unique operating frequency; such that, α≠a≠b and so on through and including the unique frequency assigned to the nth radio, fₙ. This practice ensures that RF interference does not occur and is well appreciated by those skilled in the art of cellular engineering.

Embodiment 1

In Embodiment 1 of the invention, a switching decision algorithm 102 is added to the MSC's existing call processing capabilities to regain the unique frequency that would normally be assigned to the ACC (fₐ) 105, allowing assignment of said frequency to an idle AVC. It is important to note that the intent of this design does not limit the addition of this logic to any particular system component (i.e., only to the MSC), but, rather, it describes the integral addition of such logic to existing, centralized system components the specifics of which are best dedicated by the architecture of the receiving system.

Aspect One (1) of this embodiment involves a cell site provisioned with only one AVC. With the invention implemented, ACC (f_{α}) is commissioned to operate on the same frequency as AVC (fₐ) such that f_{α}=fₐ. The switching decision algorithm 102 ensures that ACC (f_{α}) 105 is powered down whenever the AVC (fₐ) 106 is powered up into service. Subsequently, when the services of AVC (fₐ) 106 are no longer required and it is powered down as in normal operation, the switching decision algorithm 102 ensures that ACC (f_{α}) is powered on and readied to resume its normal functions until the services of AVC (fₐ) are again required and the entire process is repeated: ACC (f_{α}) is powered down whenever AVC (fₐ) is powered up into service.

Aspect Two (2) of Embodiment 1 relates to multi-AVC configurations. By example and as depicted in FIG. 1, assume “n” AVCs have been commissioned into operation. Under this arrangement, the ACC's frequency of operation will partly depend on the specific order used for assigning AVCs into service and may change, assuming frequency agility, each time it is powered up (the order of assigning AVCs into service, be it sequential, random or logical, various between equipment providers). Regardless of the specific application, the invention applies to multi-AVC configurations as follows:

If ACC (f_{α}) 105 and all supporting equipment (e.g., Combiner/Amplifier Network 107) are capable of supporting dynamic frequency assignments; then, the switching decision algorithm 102 shall power down the ACC (f_{α}) 105 whenever the last idle AVC 106 has been placed into service using the ACC's last and/or current frequency of operation. Subsequently, as soon as the services of an AVC 106 are no longer required and said AVC 106 is powered down, the switching decision algorithm 102 shall assign this unused frequency to ACC (f_{α}) 105 as ACC (f_{α}) 105 is powered on and readied to resume its normal functions.

If ACC (f_{α}) 105 or a fundamental portion of the supporting equipment (e.g., Combiner/Amplifier Network 107 is incapable of supporting dynamic frequency assignments; then, one AVC 106 must be paired with ACC (f_{α}) 105 such that: (a) this AVC is always the last AVC to be assigned into service by the switching decision algorithm 102; and, (b) the operation of ACC (f_{α}) 105 in conjunction with its paired AVC is consistent with the operation described in Aspect 1 of Embodiment 1. It is important to note that the ACC (f_{α}) 105 may only return to service once its paired AVC has been taken out of service and powered down regardless of the state of remaining, non-paired AVCs.

For either case, the operational frequency of none-paired AVCs may be either statistically assigned or dynamically assigned on a per service assignment basis by the switching decision algorithm or any other call processing capabilities resident in the MSC.

Embodiment 2

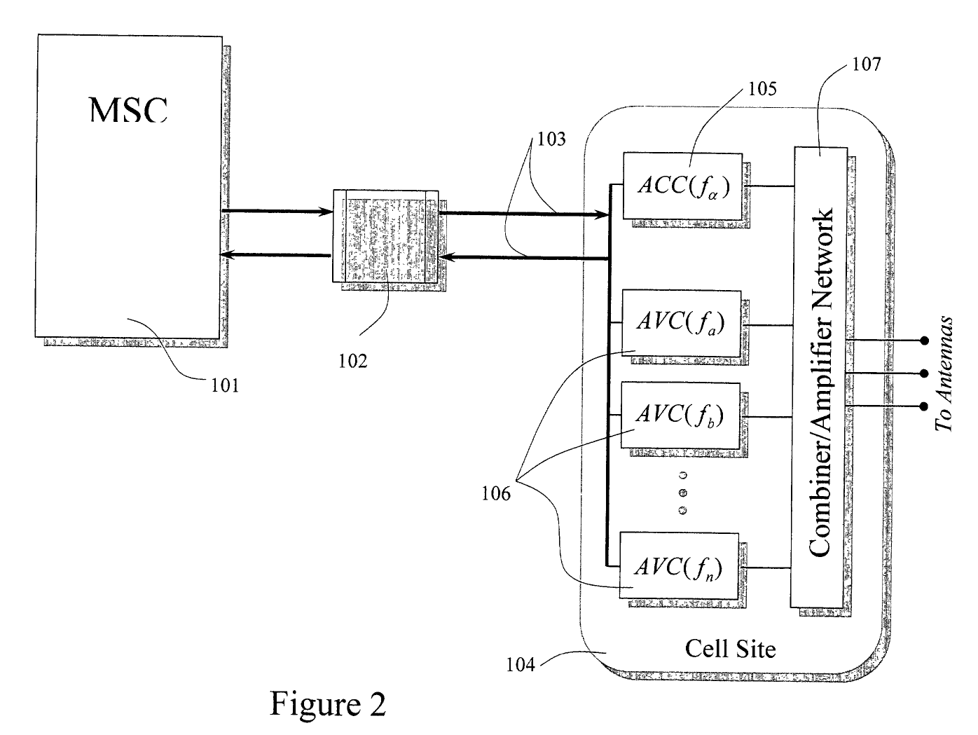

Embodiment 2 and the accompany illustration FIG. 2 modify Embodiment 1 by transferring the switching decision algorithm 102 to workings external to MSC 101. This approach requires that ancillary equipment be deployed centrally (e.g., at an MSC) or in a distributed fashion (e.g., at individual cell sites), whichever best supports the architecture or operations of a given system. Embodiment 2 postulates that messages between the cell site radios 105 and 106 and the MSC 101 are intercepted and altered or augmented to satisfy the additional switching decision algorithm by a system and method ancillary to existing system components and processes. Otherwise, Embodiment 2 retains all logical workings and detailed conditions of both Aspects 1 and 2 described above in Embodiment 1.

Embodiment 3

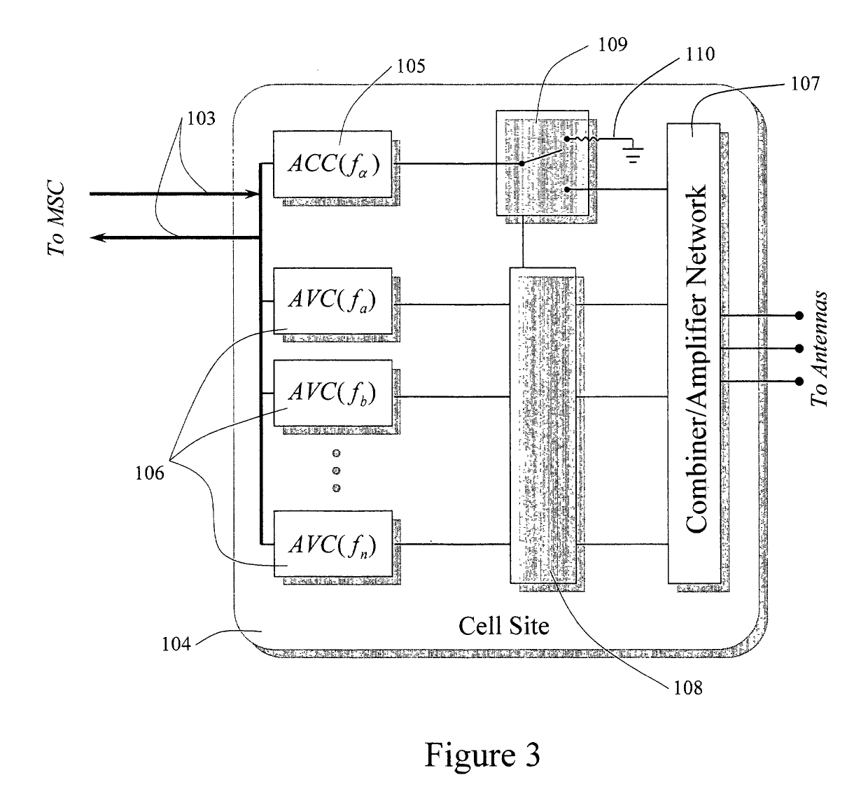

Embodiment 3 and the accompany illustration FIG. 3 implement the invention by adding ancillary RF equipment and logic to cell site radio equipment as depicted by components 108 and 109 that together comprise the switching decision algorithm. In this embodiment RF or electrical sensing equipment 108 is used to determine the baseband, multiplexed, final RF or electrical output state of the service radio(s) 106, whether said radios are powered-off or powered-on, their operating frequency and other pertinent state information. Correspondingly, logical signals are passed between components 108 and 109 to realize the configurations and conditions described in Embodiment 1, Aspects 1 and 2, whereby the output of ACC (f_{α}) 105 is either: (a) passed through to the Combiner/Amplifier Network 107 or to the next component as dedicated by the system architecture; or, (b) is transferred to a load 110 or any other suitable means of ensuring that the output power of ACC (f_{α}) 105 is not transmitted and does not cause RF interference.

Embodiment 4

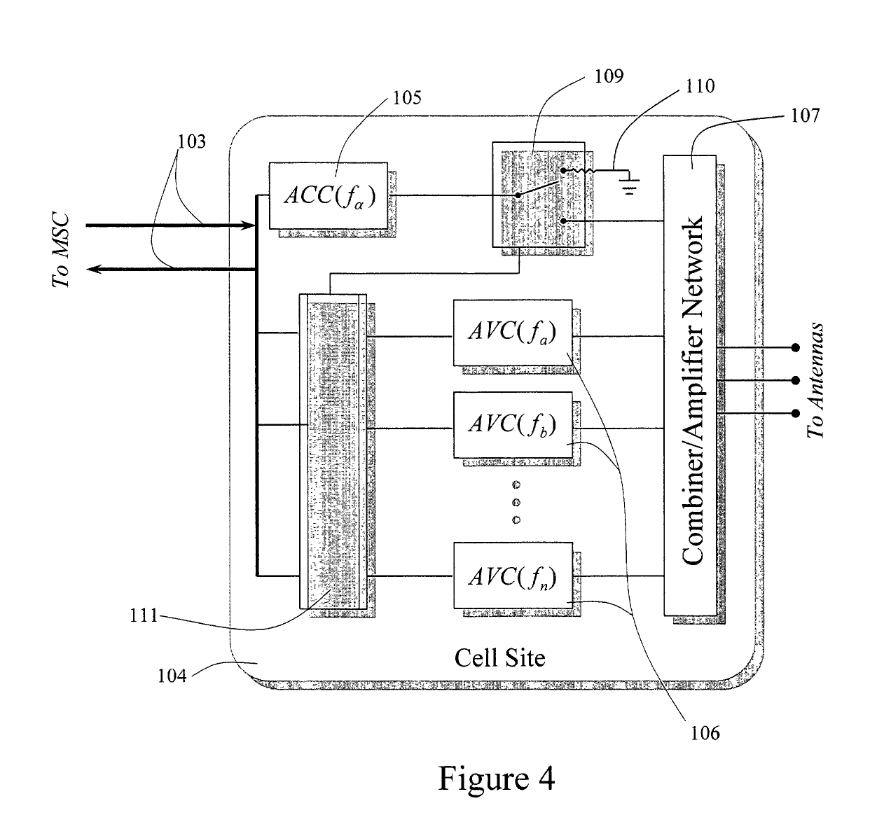

Embodiment 4 and the accompany illustration FIG. 4 implement the invention by combining ancillary logic 111 and RF equipment 109 that together comprise the switching decision algorithm. As FIG. 4 depicts and practical limitations suggest, the RF component 109 is ideally located at the cell site; however, the location of the logical component 111 is not limited to the cell site, as depicted, but may also be deployed centrally (e.g., at an MSC) or regionally. In this embodiment ancillary logic 111 is used to intercept and, perhaps, modify, control messages to the service radio(s) 106, whether said radios are powered-off or powered-on, their operating frequency and other pertinent state information. Correspondingly, logical signals are passed between components 111 and 109 to realize the configurations and conditions described in Embodiment 1, Aspects 1 and 2, whereby the output of ACC (f_{α}) 105 is either: (a) passed through to the Combiner/Amplifier Network 107 or to the next component as appropriate to the system architecture; or, (b) is transferred to a load 110 or any other suitable means of ensuring that the output power of ACC (f_{α}) 105 is not transmitted and does not cause RF interference.

Embodiment 5

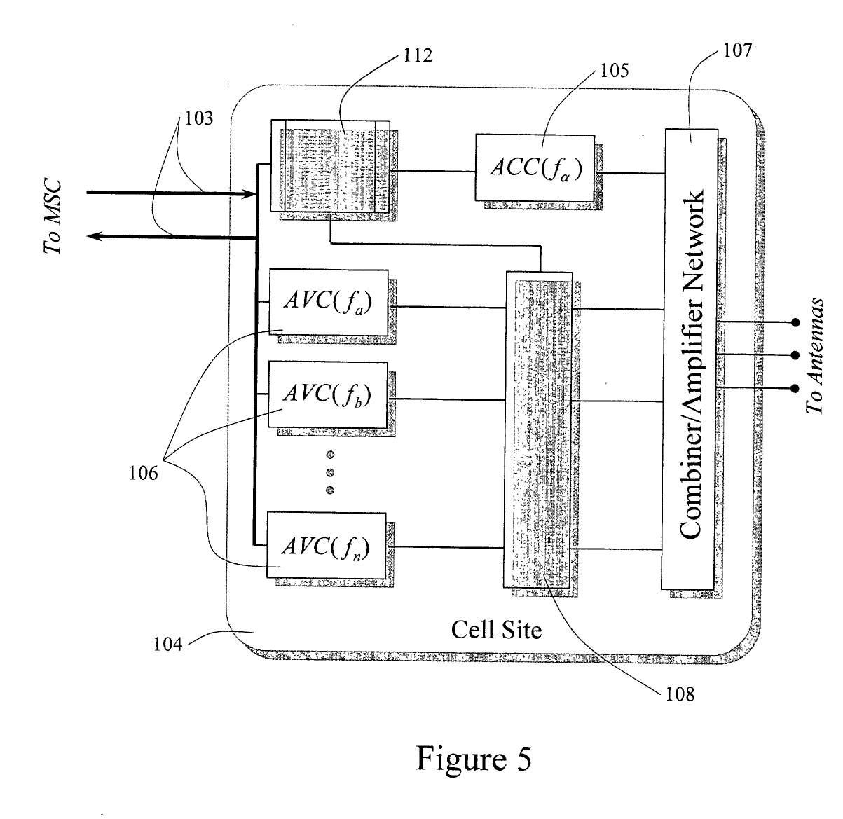

Embodiment 5 and the accompany illustration FIG. 5 implement the invention by combining ancillary logic 112 and RF equipment 108 that together comprise the switching decision algorithm. As FIG. 5 depicts and practical limitations suggest, the RF component 108 is ideally located at the cell site; however, the location of the logical component 112 is not limited to the cell site, as depicted, but may also be deployed centrally (e.g., at an MSC) or regionally. In this embodiment RF sensing equipment 108 is used to determine the baseband, multiplexed, final RF or electrical output state of the service radio(s) 106, whether said radios are powered-off or powered-on, their operating frequency and other pertinent state information. Correspondingly, logical signals are passed between components 108 and 112 to realize the configurations and conditions described in Embodiment 1, Aspects 1 and 2.

I claim:

1. A method for opportunistic control signal switching that produces a behavior wherein cell boundaries are explicitly changed in a wireless communications network.

2. System according to claim 1 where the control signal switching entails switching in time, postponing, suspending indefinitely, curtailing altogether, switching in spectral channel, switching in physical hardware.

3. System according to claim 2 where the control signal switching entails switching in time, postponing, suspending indefinitely, curtailing altogether, switching in spectral channel, switching in physical hardware causing cell boundaries in the system to be altered for devices not currently using traffic resources.

4. System according to claim 1 where the control signal switching entails switching the broadcast control signal

5. System according to claim 4 where the control signal switching entails switching broadcast control signal relating to access privileges

6. System according to claim 5 where the switching point-to-point broadcast control signal

7. System according to claim 6 where the switching point-to-point broadcast control signal that is related to use of the traffic resource

8. System according to claim 1 where the control signal switching entails cessation of transmission of said control signal on the radio resource

9. System according to claim 8 where the switching releases the radio resource for other system use

10. System according to claim 9 where the switching releases the radio resource for traffic use

11. System according to claim 1 where the switching entails cessation of transmission of the control signal on the spectral resource

12. System according to claim 11 where the switching releases the spectral resource for other system use

13. System according to claim 12 where the switching releases the spectral resource for traffic use

14. System according to claim 1 where the basis for the switching decision is centered on the desire to preferentially reallocate system resources and where said resources may be hardware, software or radio frequency based.

15. System according to claim 1 where the basis for the switching decision is centered on resource availability.

16. System according to claim 1 where the basis for the switching decision is centered on the need for end units to obtain positive pre-acknowledgement of service availability.

17. System according to claim 1 where the basis for the switching decision is centered on the desire for end units to have greater certainty of service availability.

18. System according to claim 1 wherein opportunistic control signal switching is realized according to Embodiment 1 previously described and depicted in FIG. 1 in which a switching decision algorithm 102 is added to the MSC's 101 existing call processing capabilities.

19. System according to claim 1 wherein opportunistic control signal switching is realized according to Embodiment 2 previously described and depicted in FIG. 2 in which a switching decision algorithm 102 is an external adjunct to the workings of MSC 101 and deployed in ancillary equipment selected from the group consisting of: (1) centrally located; (2) physically distributed.

20. System according to claim 1 wherein opportunistic control signal switching is realized according to Embodiment 3 previously described and depicted in FIG. 3 in which a switching decision algorithm 102 is realized by adding ancillary RF equipment and logic to cell site radio equipment as depicted by components 108 and 109 of FIG. 3. In this embodiment, sensing equipment 108 is used to determine the output state of the service radio(s) 106, and, correspondingly, logical signals are passed between components 108 and 109 to assign said control signals to a preferred state.

21. System according to claim 1 wherein opportunistic control signal switching is realized according to Embodiment 4 previously described and depicted in FIG. 4 in which ancillary logic 111 and RF equipment 109 together comprise the switching decision algorithm. The RF component 109 and logical component 111 may be located at the cell site or may be deployed centrally (e.g., at an MSC) or regionally. In this embodiment ancillary logic 111 is used to intercept, inspect and modify control signaling to the service radio(s) 106, and, correspondingly, logical signals are passed between components 111 and 109 to assign said control signals to a preferred state.

22. System according to claim 1 wherein opportunistic control signal switching is realized according to Embodiment 5 previously described and depicted in FIG. 5 in which ancillary logic 112 and RF equipment 108 together comprise the switching decision algorithm. The RF component 108 and logical component 112 may be located at the cell site or may be deployed centrally (e.g., at an MSC) or regionally. In this embodiment RF sensing equipment 108 is used to intercept, inspect and modify control signaling to the service radio(s) 106, and, correspondingly, logical signals are passed between components 108 and 112 to assign said control signals to a preferred state.
